(19) United States
(12) Patent Application Publication
(10) Pub. No.: US 2015/0161576 A1
(43) Pub. Date: Jun. 11, 2015

(54) SYSTEM AND METHOD FOR FINANCIAL TRANSFERS FROM A FINANCIAL ACCOUNT USING SOCIAL MEDIA

(71) Applicant: Capital One Financial Corporation, McLean, VA (US)

(72) Inventor: Shelley Mary KEEN, Windsor (GB)

(21) Appl. No.: 14/566,872

(22) Filed: Dec. 11, 2014

Related U.S. Application Data
(60) Provisional application No. 61/914,719, filed on Dec. 11, 2013.

(51) Int. Cl. G06Q 20/10; G06Q 50/00; G06Q 20/40; G06Q 20/38; G06Q 20/02

(52) U.S. Cl. CPC G06Q 20/10; G06Q 20/383; G06Q 20/02; G06Q 20/4016; G06Q 50/01

(57) ABSTRACT

Systems and methods for transferring funds from a financial account held at a financial institution to a recipient using a social media platform include a social linking application programming interface (API) that establishes a link between a sender social media account that is associated with sender financial account data and at least one recipient social media account that is associated with recipient financial account data; a database that maintains the link between the at least one linked sender financial account and at the least one linked recipient financial account, an input/output interface that receives, via a network, a request from a sender financial institution identified in the linked sender financial account data to transfer funds from a sender social media subscriber associated with the sender social media account to a recipient social media subscriber associated with the recipient social media account, wherein the request identifies the linked recipient social media account and includes a transfer amount, and a transfer processor that queries the data storage for recipient financial account data based on the request, transmits the recipient financial account data to a sender financial institution via the social linking API, and receives confirmation of a completed transfer between the sender financial institution and a recipient financial institution associated with the recipient financial account data.

### CROSS-REFERENCE TO RELATED APPLICATIONS

This application contains subject matter related to and claims the benefit of U.S. Provisional Application No. 61/914,719, filed on Dec. 11, 2013, the entire contents of which is incorporated herein by reference.

### FIELD OF THE DISCLOSURE

The present disclosure relates to a system and method for transferring funds from a financial account held at a financial institution to a recipient using a social media platform.

1. Background of the Disclosure

Currently, social media systems allow users to purchase and send electronic gift cards for a social media account holder through the social media system. However, utilizing these current methods require the use of a financial transaction card and/or third party e-commerce businesses to transfer funds from a sending account to the merchant providing the electronic gift card. These methods do not allow an account holder to directly access a financial account that resides with a financial institution in order to perform the electronic transfer of funds from the financial account to a recipient using a social media platform and ultimately to a financial account associated with the social media recipient. These and other drawbacks exist.

2. Summary of the Disclosure

According to the various embodiments of the present disclosure, a system and method for transferring funds from a financial account held at a financial institution to a recipient account using a social media platform account holder's social media may include receiving an information, linking the account holder's social media information with accounts held by the account holder with the account provider, receiving a request to transfer funds from an account linked to a social media subscriber to a recipient social media subscriber, and electronically transferring funds from the account holder to the recipient social media subscriber via the social media platform.

In various embodiments, systems and methods for transferring funds from a financial account held at a financial institution to a recipient using a social media platform include a social linking application programming interface (API) that establishes a link between a sender social media account that is associated with sender financial account data and at least one recipient social media account that is associated with recipient financial account data; a database that maintains the link between the at least one linked sender financial account and at the least one linked recipient financial account, an input/output interface that receives, via a network, a request from a sender financial institution identified in the linked sender financial account data to transfer funds from a sender social media subscriber associated with the sender social media account to a recipient social media subscriber associated with the recipient social media account, wherein the request identifies the linked recipient social media account and includes a transfer amount, and a transfer processor that queries the data storage for recipient financial account data based on the request, transmits the recipient financial account data to a sender financial institution via the social linking API, and receives confirmation of a completed transfer between the sender financial institution and a recipient financial institution associated with the recipient financial account data.

In various embodiments, systems and methods for transferring funds from a financial account held at a financial institution to a recipient using a social media platform include a database that maintains a financial account of an account holder, wherein the account holder is a sender subscriber of a social media system, a social media interface that is coupled via a network to a social linking application programming interface (API) that establishes a link between the sender subscriber's social media account and at least one recipient social media account that is associated with recipient financial account data, wherein the link is maintained in a database of the social media system, and an input/output interface that transmits, via a network, a request to transfer funds from the financial account to a recipient social media subscriber associated with the recipient social media account, wherein the request identifies the linked recipient social media account and includes a transfer amount and confirmation of a completed transfer between the sender subscriber's financial account and a recipient financial institution associated with the recipient financial account data.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a system for transferring funds from a financial account held at a financial institution to a recipient using a social media platform according to an embodiment of the disclosure;

FIG. 2 depicts an example embodiment of a system for transferring funds from a financial account held at a financial institution to a recipient using a social media platform according to an embodiment of the disclosure;

FIG. 3 depicts an example embodiment of system components for transferring funds from a financial account held at a financial institution to a recipient using a social media platform according to an embodiment of the disclosure;

FIG. 4 depicts an example flow chart illustrating a method for transferring funds from a financial account held at a financial institution to a recipient using a social media platform according to an embodiment of the disclosure;

FIG. 5 depicts an example embodiment of a system for transferring funds from a financial account held at a financial institution to a recipient using a social media platform according to an embodiment of the disclosure; and

FIG. 6 depicts an example embodiment of a system for transferring funds from a financial account held at a financial institution to a recipient using a social media platform according to an embodiment of the disclosure.

### DETAILED DESCRIPTION OF THE EMBODIMENTS

The following description is intended to convey a thorough understanding of the embodiments described by providing a number of specific example embodiments and details involving systems and methods for transferring funds from a financial account held at a financial institution to a recipient using a social media platform. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A social media system, account provider system, merchant system, and/or account holder device, and system supporting a connection between social media systems, financial account provider systems, merchant systems, and/or mobile devices, are used as examples for the disclosure. The disclosure is not intended to be limited to social media systems, account provider systems, merchant systems, and/or mobile devices only.

The example embodiments disclosed herein are directed to systems and methods for transferring funds from a financial account held at a financial institution to a recipient using a social media platform, and the like. According to the various embodiments of the present disclosure, a social media system may include a system associated with a social media provider, such as Facebook, Twitter, MySpace, Foursquare, Instagram, Google+, LinkedIn, and the like. Each social media system may host subscriber accounts holding account data, such as, for example, subscriber name, subscriber phone number, subscriber address, subscriber occupation, and/or subscriber location information. Subscriber location information may include updated data received from the subscriber, or another account related to the subscriber, regarding a current location of the subscriber. Subscriber location information may be provided by a mobile device and/or other computing device associated with the subscriber. For example, a subscriber may check-in to a location using the subscriber's mobile device. Also, a subscriber may be checked into a location by an account related to the subscriber using a mobile or other computing device. The device may then transmit the check-in location data to the social media system, thus updating subscriber location information stored on the social media system.

According to the various embodiments of the present disclosure, a system and for transferring funds from a financial account held at a financial institution to a recipient using a social media platform may further include linking a social media subscriber account held with the social media system to a financial account held with an account provider system. U.S. patent application Ser. No. 14/031,263 entitled “System and Method for Determining Social Statements,” U.S. Provisional Patent Application No. 61/737,399 entitled “System and Method for Synching a Financial Account with a Social Network Account,” and U.S. Provisional Patent Application No. 61/924,727, entitled “System and Method for Fraud Detection Using Social Media,” each disclose systems and methods relating to social media accounts associated with financial accounts, the contents of which are incorporated by reference in their entirety.

Linking the social media system with the account provider system may include receiving, at the social media system, account details of a financial account held at an account provider system and/or receiving, at the account provider system, account details of a subscriber account held at a social media system. The linking process may include an opt-in process. For example, a financial account holder may opt-in and allow the financial account provider to access data held at a social media system associated with the account holder. Additionally, the social media subscriber may opt-in and allow the social media system to access data held at a financial account provider system associated with the subscriber. The social media subscriber also may opt-in and allow the social media system to provide data to the financial account provider system to enable fraud detection. Data provided by the social media system may include location data and/or social media preference data, including privacy preferences associated with the social media account. Moreover, the linking process may occur through a social linking application programming interface (“API”).

A social linking API may allow certain data to be transmitted through the API so that a social media system may communicate with an account provider system. The social linking API may prevent data other than approved data to be transmitted through the API. For example, the API may only support subscriber name, subscriber e-mail address, subscriber identification information, and subscriber location information to be transmitted from the social media system to the account provider system. Also, the social linking API may allow subscriber relationship data to be transmitted to the account provider system if a social media subscriber opts-in to allow relationship data to be provided to the account provider system.

By linking the social media system with the account provider system, an account holder authorizes the social media system to transmit certain subscriber data, such as subscriber location data, from the social media system to the account provider system. Moreover, by linking the social media system with the account provider system, a social media subscriber authorizes the account provider system to transmit account holder data, such as account data, including, for example, an account number and a routing number; a transfer amount; and/or recipient data, including, for example, recipient name, recipient email address, recipient phone number, and/or recipient social media identification data.

A sending party and a recipient party may have social media accounts and financial institution accounts linked in order to participate in methods for transferring funds using a social media platform. For example, a sending party may have a linked social media account and financial institution account in order to transfer funds via a social media platform to a recipient social media account holder. Also, a recipient party may have a linked social media account and financial institution account in order to facilitate the transfer of funds from a sending social media account holder to the recipient social media account holder. This transfer may be executed by transferring funds from a linked sending financial account to a linked recipient financial account using a social media platform.

A social linking API may provide encryption and filtering functionality to prevent, for example, identity theft and fraudulent transactions. For example, the social linking API may filter out personally identifying information that is unnecessary to carry out the claimed methods, such as, social security numbers. A social inking API may also encrypt, for example, account and routing numbers to ensure that any passing account identifying data is secure during transmission and storage.

As used herein a “subscriber” refers to one associated with a social media system and an “account holder” refers to one associated with a financial account provider system. The account provider system and/or subscriber system may store data indicative of a linked account, such as an identifier and a status. The identifier may be utilized in the social linking API to link a subscriber account and a financial account in order to perform a requested transfer of funds from a first financial account held at a financial institution by a first subscriber to a second financial account held by a second subscriber. A status may indicate if a subscriber and/or account holder has a linked account. Where a recipient subscriber does not have a linked subscriber account and financial account, the recipient subscriber may be prompted to provide account holder data in order to receive the transfer of funds from a sending financial account.

The account provider system may include a fraud detection module that operates various fraud detection algorithms. For example, a fraud detection algorithm may take into consideration a number of variables including, for example, sending account holder data, sending subscriber data, recipient account holder data, recipient subscriber data, time of day, transfer amount, and/or social media preference data. Each of these variables may be user-defined, defined by the account provider system, and/or defined by the social media system. For example, a subscriber may define recipients that are authorized to receive a funds transfer from the subscriber, such as a listing of social media connections. In another example, the account provider system may define transfer amounts where account holder may select a one of the account provider-defined amounts. U.S. Provisional Patent Application No. 61/789,858 entitled “System and Method for Fraud Management,” discloses further fraud management methods, the contents of which are incorporated by reference in their entirety. Additionally, U.S. Pat. No. 7,857,212, entitled “Method and system for authorizing card account transactions by geographic region,” discloses fraud prevention using authorizations by geographic region, the contents of which are incorporated by reference in their entirety.

The system for transferring funds from a financial account held at a financial institution to a recipient financial account using a social media platform. Once a sending financial account and sending social media account are linked, a sending party may initiate a funds transfer to a recipient social media subscriber. The recipient social media subscriber may also have a social media account and financial account linked. A recipient social media subscriber may be an individual or may be a business. Where a recipient social media subscriber is a business, the sending social media subscriber may indicate a third party social media subscriber who may use the funding sent to the recipient social media subscriber. For example, where a third party is out to dinner and a sending social media subscriber wishes to pay for the bill at the restaurant where the restaurant is also a social media subscriber, the sending social media subscriber may transfer funds to the restaurant via the social media platform using a transfer module/social linking API and indicate that it is to pay the bill associated with a third party social media subscriber. Using the embodiments described herein, the transfer of funds to the restaurant via the social media platform may result in the funds being transferred into a linked financial account associated with the restaurant.

A transfer module at the sending financial account provider system transmits a transfer request to a social media system housing a recipient social media account. A transfer module at the recipient social media account may access data storage associated with the social media system to determine whether the recipient social media account is linked to a recipient financial account. For example, a transfer module may query data storage and where a recipient social media account indicates a linked financial account, the transfer module may query data storage for linked financial account information. Linked financial account information may be encrypted and may include, for example, an account number, a routing number, an account holder name, address, phone number, or other identifying information. Linked recipient financial account information may be transmitted to the sending account provider system via a social linking API. According the transfer module at the sending financial account provider system may initiate a funds transfer using the recipient financial account information. A fraud module housed at the sending financial account provider system and/or recipient financial account provider system may ensure a funds transfer is protected from fraudulent transfers. Once a transfer of funds is successful between a sending financial account and a recipient financial account, a confirmation module at the sending financial account system may provide confirmation data to a social media system in order to publish and/or provider confirmation details to the sending social media account and the recipient social media account.

A confirmation module also may utilize a social media API when transmitting confirmation data to a social media system. Confirmation data may include, for example, a receipt of transfer, a time and date of transfer, a sending account holder, a recipient account holder, a sending social media subscriber, and/or a recipient social media subscriber.

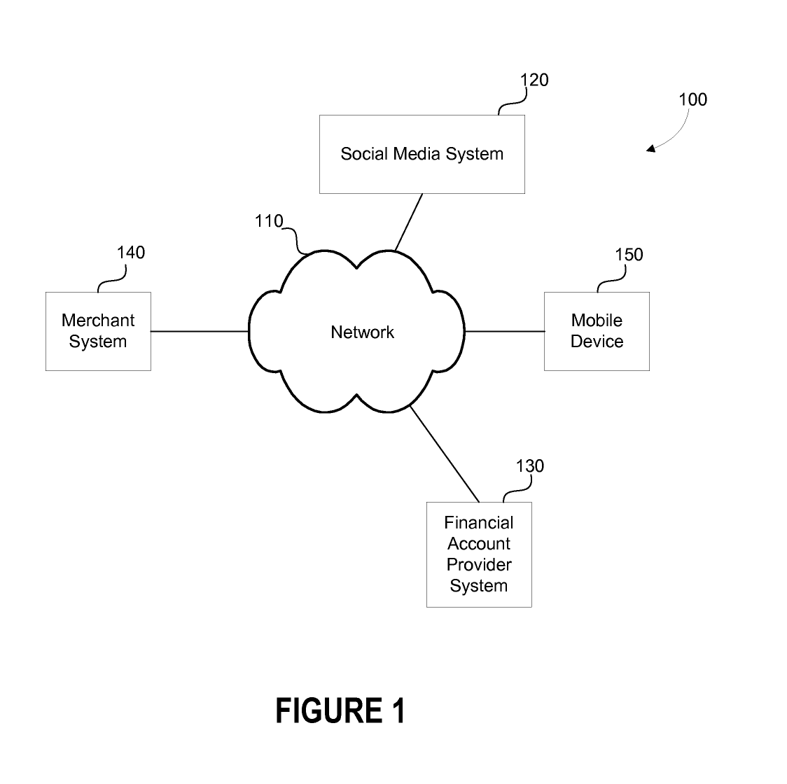

FIG. 1 depicts an example embodiment of a system for fraud detection using social media 100. The system 100 may include various systems connected to each other over a network 110. These systems include a social media system 120, an account provider system 130, a merchant system 140, and a mobile device 150.

The network 110 may be one or more of a wireless network, a wired network, or any combination of a wireless network and a wired network. For example, network 110 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 110 may include, without limitation, telephone lines, fiber optics, IEEE Ethernet 902.3, a wide area network (WAN), a local area network (LAN) or a global network such as the Internet. Also, network 110 may support an Internet network, a wireless communication network, a cellular network, or the like, or any combination thereof. Network 110 may further include one network, or any number of example types of networks mentioned above, operating as a stand-alone network or in cooperation with each other. Network 110 may utilize one or more protocols of one or more network elements to which they are communicatively couples. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

A social media provider may access network 110 through one or more social media systems 120 that may be communicatively coupled to the network 110. An account provider, such as a financial institution, may access the network 110 through one or more financial account providers systems 130 that may be communicatively coupled to the network 110. One or more merchants may access the network 110 through one or more merchant systems 140 that also may be communicatively coupled to the network 110. Additionally, one or more social media subscribers and/or account holders may be communicatively coupled to the network 110 through a mobile device 150. Although social media system 120, account provider system 130, merchant system 140, and mobile device 150 are depicted as a single systems and/or devices, it should be appreciated that according to one or more embodiments, mobile social media system 120, account provider system 130, merchant system 140, and mobile device 150 may comprise a plurality of systems and/or devices. Moreover, mobile device 150 may also include any other form of computing device described below, at which a subscriber and/or account holder may access network 110. Mobile device 150 may use various software and hardware components to access social media system and/or financial account system.

An example mobile social media system 120, account provider system 130, merchant system 140, and/or mobile device 150 may include one or more network-enabled computers to process instructions for methods for transferring funds from a financial account held at a financial institution to a recipient using a social media platform 400. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 100 may execute one or more software applications for methods of fraud detection using social media data.

The social media system 120, account provider system 130, merchant system 140, and/or mobile device 150 may further include, for example, a processor, which may be several processors, a single processor, or a single device having multiple processors. The social media system 120, account provider system 130, merchant system 140, and/or mobile device 150 may store information in various electronic storage media, such as, for example, a database (not shown) and/or other data storage. Electronic information may be stored in the application social media system 120, account provider system 130, merchant system 140, and/or mobile device 150 in a format such as, for example, a flat file, an indexed file, a hierarchical database, a post-relational database, a relational database, such as a database created and maintained with software from, for example Oracle® Corporation, Microsoft® Excel file, Microsoft® Access file, or any other storage mechanism.

The social media system 120, account provider system 130, merchant system 140, and/or mobile device 150 may send and receive data using one or more protocols. For example, data may be transmitted and received using Wireless Application Protocol (WAP), Multimedia Messaging Service (MMS), Enhanced Messaging Service (EMS), Short Message Service (SMS), Global System for Mobile Communications (GSM) based systems, Time Division Multiplexing (TDM) based systems, Code Division Multiples Access (CDMA) based systems suitable for transmitting and receiving data. Data may be transmitted and received wirelessly or may utilize cabled network connections or telecom connections, fiber connections, traditional phone wireline connection, a cable connection, or other wired network connection.

Each social media system 120, account provider system 130, merchant system 140, and/or mobile device 150 of FIG. 1 also may be equipped with physical media, such as, but not limited to, a compact disc (CD), a digital versatile disc (DVD), a floppy disk, a hard drive, read only memory (ROM), random access memory (RAM), as well as other physical media capable of storing software, or combinations thereof. Social media system 120, account provider system 130, merchant system 140, and/or mobile device 150 may be able to perform the functions associated with methods of transferring funds from a financial account held at a financial institution to a recipient using a social media platform. Social media system 120, account provider system 130, merchant system 140, and/or mobile device 150 may, for example, house the software for methods of transferring funds from a financial account held at a financial institution to a recipient using a social media platform obviating the need for a separate device on the network 110 to run the methods housed on social media system 120, account provider system 130, merchant system 140, and/or mobile device 150.

Furthermore, the information stored in a database (not shown) may be available over the network 110, with the network containing data storage. A database housed on social media system 120, account provider system 130, merchant system 140, mobile device 150, and/or the network 110, may store, or may connect to external data warehouses that stores, account holder data, social media subscriber data, and/or funds transfer data.

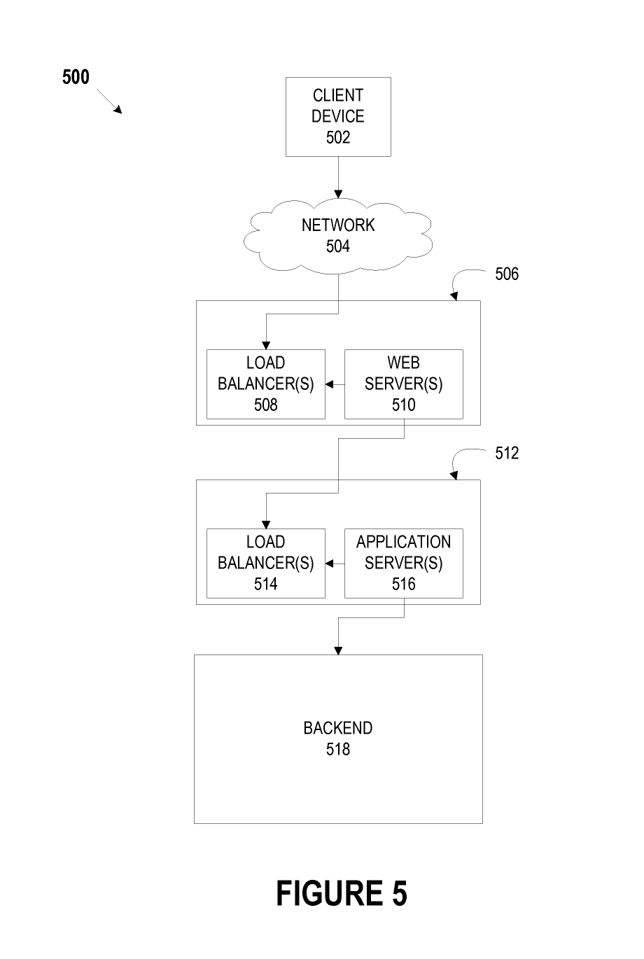

FIG. 5 depicts an example system 500 that may enable a financial institution, for example, to provide network services to its customers. System 500 also may enable, for example, a social media system to provide network services to its subscribers. System 500 also may enable, for example, a financial institution and social media system to link accounts. As shown in FIG. 5, system 500 may include a client device 502, a network 504, a front-end controlled domain 506, a back-end controlled domain 512, and a backend 518. Front-end controlled domain 506 may include one or more load balancers 508 and one or more web servers 510. Back-end controlled domain 512 may include one or more load balancers 514 and one or more application servers 516.

Client device 502 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 500 may execute one or more software applications to enable, for example, network communications.

Client device 502 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 504 may be one or more of a wireless network, a wired network, or any combination of a wireless network and a wired network. For example, network 504 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 504 may include, without limitation, telephone lines, fiber optics, IEEE Ethernet 902.3, a wide area network (WAN), a local area network (LAN) or a global network such as the Internet. Also, network 504 may support an Internet network, a wireless communication network, a cellular network, or the like, or any combination thereof. Network 504 may further include one network, or any number of example types of networks mentioned above, operating as a stand-alone network or in cooperation with each other. Network 504 may utilize one or more protocols of one or more network elements to which they are communicatively couples. Network 504 may translate to or from other protocols to one or more protocols of network devices. Although network 504 is depicted as a single network, it should be appreciated that according to one or more embodiments, network 504 may comprise a plurality of interconnected networks, such as, for example, the Internet, a service provider's network, a cable television network, corporate networks, and home networks.

Front-end controlled domain 506 may be implemented to provide security for backend 518. Load balancer(s) 508 may distribute workloads across multiple computing resources, such as, for example computers, a computer cluster, network links, central processing units or disk drives. In various embodiments, load balancer(s) 510 may distribute workloads across, for example, web server(S) 516 and/or backend 518 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 508 may include software that monitoring the port where external clients, such as, for example, client device 502, connect to access various services of a financial institution, for example. Load balancer(s) 508 may forward requests to one of the application servers 516 and/or backend 518 servers, which may then reply to load balancer 508. This may allow load balancer(s) 508 to reply to client device 502 without client device 502 ever knowing about the internal separation of functions. It also may prevent client devices from contacting backend servers directly, which may have security benefits by hiding the structure of the internal network and preventing attacks on backend 518 or unrelated services running on other ports, for example.

A variety of scheduling algorithms may be used by load balancer(s) 508 to determine which backend server to send a request to. Simple algorithms may include, for example, random choice or round robin. Load balancers 508 also may account for additional factors, such as a server's reported load, recent response times, up/down status (determined by a monitoring poll of some kind), number of active connections, geographic location, capabilities, or how much traffic it has recently been assigned.

Load balancers 508 may be implemented in hardware and/or software. Load balancer(s) 508 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 510 may include hardware (e.g., one or more computers) and/or software (e.g., one or more applications) that deliver web content that can be accessed by, for example a client device (e.g., client device 502) through a network (e.g., network 504), such as the Internet. In various examples, web servers, may deliver web pages, relating to, for example, online banking applications and the like, to clients (e.g., client device 502). Web server(s) 510 may use, for example, a hypertext transfer protocol (HTTP or sHTTP) to communicate with client device 502. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 510 may respond with the content of that resource or an error message if unable to do so. The resource may be, for example a file on stored on backend 518. Web server(s) 510 also may enable or facilitate receiving content from client device 502 so client device AO2 may be able to, for example, submit web forms, including uploading of files.

Web server(s) also may support server-side scripting using, for example, Active Server Pages (ASP), PHP, or other scripting languages. Accordingly, the behavior of web server(s) 510 can be scripted in separate files, while the actual server software remains unchanged.

Load balancers 514 may be similar to load balancers 508 as described above.

Application server(s) 516 may include hardware and/or software that is dedicated to the efficient execution of procedures (e.g., programs, routines, scripts) for supporting its applied applications. Application server(s) 516 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 516 may act as a set of components accessible to, for example, a financial institution or other entity implementing system 500, through an API defined by the platform itself. For Web applications, these components may be performed in, for example, the same running environment as web server(s) 510, and application servers 516 may support the construction of dynamic pages. Application server(s) 516 also may implement services, such as, for example, clustering, fail-over, and load-balancing. In various embodiments, where application server(s) 516 are Java application servers, the web server(s) 516 may behaves like an extended virtual machine for running applications, transparently handling connections to databases associated with backend 518 on one side, and, connections to the Web client (e.g., client device 502) on the other.

Backend 518 may include hardware and/or software that enables the backend services of, for example, a financial institution or other entity that maintains a distributes system similar to system 500. For example, backend 518 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 518 may be associated with various databases, including account databases that maintain, for example, customer account information, product databases that maintain information about products and services available to customers, content databases that store content associated with, for example, a financial institution, and the like. Backend 518 also may be associated with one or more servers that enable the various services provided by system 500. For example, Backend 518 may include hardware and/or software that enables the backend services of, for example, a social media system that provides social media services to its subscribers.

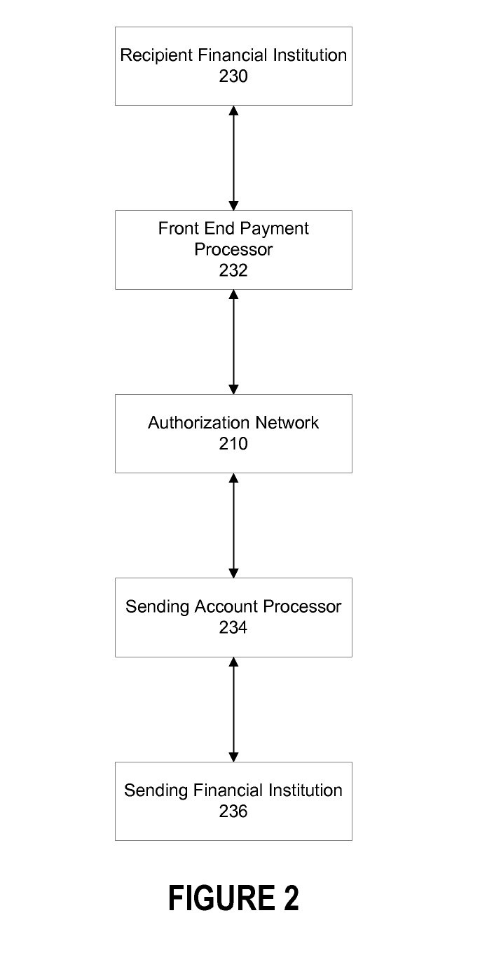

Referring now to FIG. 2, where the recipient financial institution and the sending financial institution are not the same financial institution, transfer authorization may occur over an authorization network. An authorization network 210 may allow a recipient financial institution 230 to submit payment authorization requests and process transfers. An authorization network 210 may be used to communicate payment requests from a recipient financial institution 230 to a sending financial institution 236 as well as payment determinations from the sending financial institution 236 to the recipient financial institution 230. In communicated payment requests, a recipient financial institution 230 may pass transfer information, which includes payment information such as account data, to a front-end payment processor 232 that maintains connections with a variety of networks 210 connected to sending financial institutions 236, such as card associations, banking institutions, and other settlement service providers. The front-end payment processor may pass along the transaction information to the appropriate network 210, which may then route the transfer information to the sending financial institution processor (or a back-end payment processor) 234. The sending account processor 234 may check the payment and transfer details in order to approve (or deny) payment. This may include a fraud detection algorithm. The sending financial institution 236 may concurrently verify a payment for the received transfer information. The verification of payment (or denial of payment) may then be sent from the sending financial institution 236 via the sending account processor 234 through the authorization network 210 and front-end processor 232 to the recipient financial institution 230.

The authorization system illustrated in FIG. 2 may be used to both perform real-time authorization as well as batch payment processing. In a batch payment processing system, the sending account processor 234 may perform a payment authorization in real-time and then subsequently process the payment at the sending financial institution 236 in batch processing.

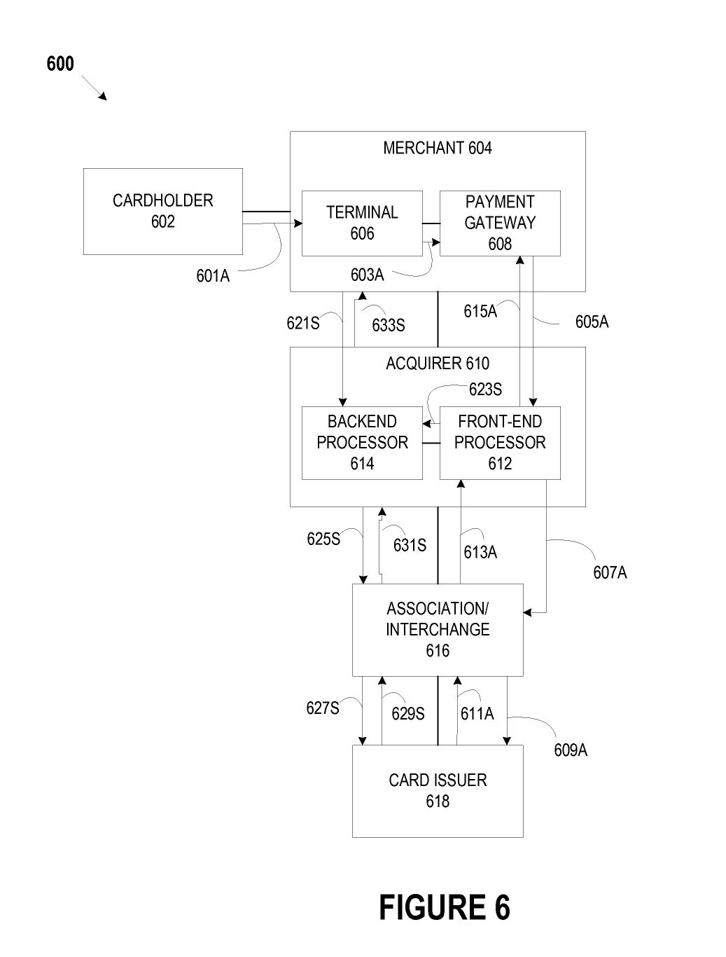

FIG. 6 illustrates an example system 600 and method for card authorization. In various embodiments, system 600 may allow a recipient financial institution 230 to submit payment authorization requests and process transfers. As shown and described in FIG. 6, merchants, cardholders and financial institutions may be connected with a card association network to enable secure transactions and timely payments. System 600 may include a cardholder 602, merchant 604, Acquirer 610, Association/Interchange 616, and card issuer 618.

Cardholder 602 may be any card holder, including a credit card holder, debit card holder, stored value card holder and the like. Cardholder 602 may possess a plastic card or carry a device (e.g., a mobile device) that securely stores card credentials and is capable of transmitting the card credentials to, for example, a PoS terminal (e.g., terminal 606). Cardholder 602 may interact with a merchant (e.g., merchant 604) by presenting a card or card credentials to a terminal (e.g., terminal 606).

Merchant 604 may be any merchant that accepts payment from a cardholder, for example. Merchant 604 may be any retailer, service provider, business entity, or individual that accepts payments. Merchant 604 may include software, firmware and hardware for accepting and/or processing payments. For example, as illustrated in FIG. 6, merchant 604 may include a terminal 606 and a payment gateway 608. Terminal 606 and payment gateway 608 may comprise the physical or virtual device(s) used by merchant 604 to communicate information to front-end processor 612 of acquirer 610. Terminal 606 may be similar to PoS system [Y00] as shown and described in Figure Y. In various embodiments, payment gateway 608 may be an e-commerce application service provider service that authorizes payments for merchants. As such, payment gateway 608 may be a virtual equivalent of a PoS terminal and interface with, for example, a billing system of merchant 604 and pass data to front-end processor 612 of acquirer 610.

Acquirer 610 may be, for example, a financial institution or bank, that holds the contract for providing payment processing services to merchant 604. Merchant 604 may have a merchant account that may serve as a contract under which Acquirer 610 may extend a line of credit to a merchant who wishes to accept, for example, credit card transactions. As shown in FIG. 6, Acquirer 610 may be associated with front-end processor 612 and back-end processor 614.

In various examples, front-end processor 612 may be a platform that card terminal 606 and/or payment gateway 608 communicate with when approving a transaction. Front-end processor 612 may include hardware, firmware, and software to process transactions. Front-end processor 612 may be responsible for the authorization and capture portion of credit card transaction. Front-end processor 612 also may include additional front-end platform interconnections to support, for example, ACH and debit transactions.

Backend processor 614 may be a platform that takes captured transactions from front-end processor 612 and settles them through an Interchange system (e.g., association/interchange 616). Back-end processor 614 may generate, for example, daily ACH files for merchant settlement. Back-end processor 614 also may handle chargeback handling, retrieval request and monthly statements.

Association/interchange 616 may be the consumer payment system whose members are the financial institutions that issue payment cards and/or sign merchant to accept payment cards. Example associations/interchanges 616 may include, Visa®, MasterCard®, and AmericanExpress®. Association/interchange 616 may include one or more computer systems and networks to process transactions.

Issuer 618 may be a financial institution that issues payment cards and maintains a contract with cardholders for repayment. In various embodiments, issuer 618 may issue credit, debit, and/or stored value cards, for example. Example issuers may include, Capital One, Bank of America, Citibank, and the like.

In various embodiments, processing a payment card transaction may involves two stages: (1) authorization and (2) clearing and settlement. Authorization may refer to an electronic request that is sent through various parties to either approve or decline the transaction. Clearing and Settlement may refer to settlement of the parties' settle accounts to enable the parties to get paid.

During authorization, cardholder 602 may present payment card as payment (601A) at merchant 604 PoS terminal 606, for example. Merchant 604 may enter card into a physical PoS terminal 606 or submit a credit card transaction to a payment gateway 608 on behalf of cardholder 602 via secure connection from a Web site, retail location, or a wireless device.

Payment gateway 608 may receive the secure transaction information (603A) and may pass the secure transaction information (605A) via a secure connection to the merchant acquirer's 610 front-end processor 612.

Front-end processor 612 may submit the transaction (607A) to association/interchange 616 (e.g., a network of financial entities that communicate to manage the processing, clearing and settlement of credit card transactions). Association/interchange 616 may route the transaction (609A) to the customer's Issuer 618. Issuer 618 may approve or decline the transaction and passes the transaction results back (611A) through association/interchange 616. Association/interchange then may relay the transaction results (613A) to front-end processor 612.

Front-end processor 612 may relay the transaction results (615A) back to the payment gateway 608 and/or terminal 606. Payment gateway 608 may store the transaction results and sends them to merchant 604. Merchant 604 may receive the authorization response and complete the transaction accordingly.

During settlement, merchant 604 may deposit the transaction receipt (621S) with acquirer 610 via, for example, a settlement batch. Captured authorizations may be passed (623S) from front-end processor 612 to the back-end processor 614 for settlement. Back-end processor may generates ACH files for merchant settlement. Acquirer may submit settlement files (625S, 627S) to Issuer 618 for reimbursement via association/interchange 616. Issuer 618 may post the transaction and pay merchant 604 (629S, 631S, 633S).

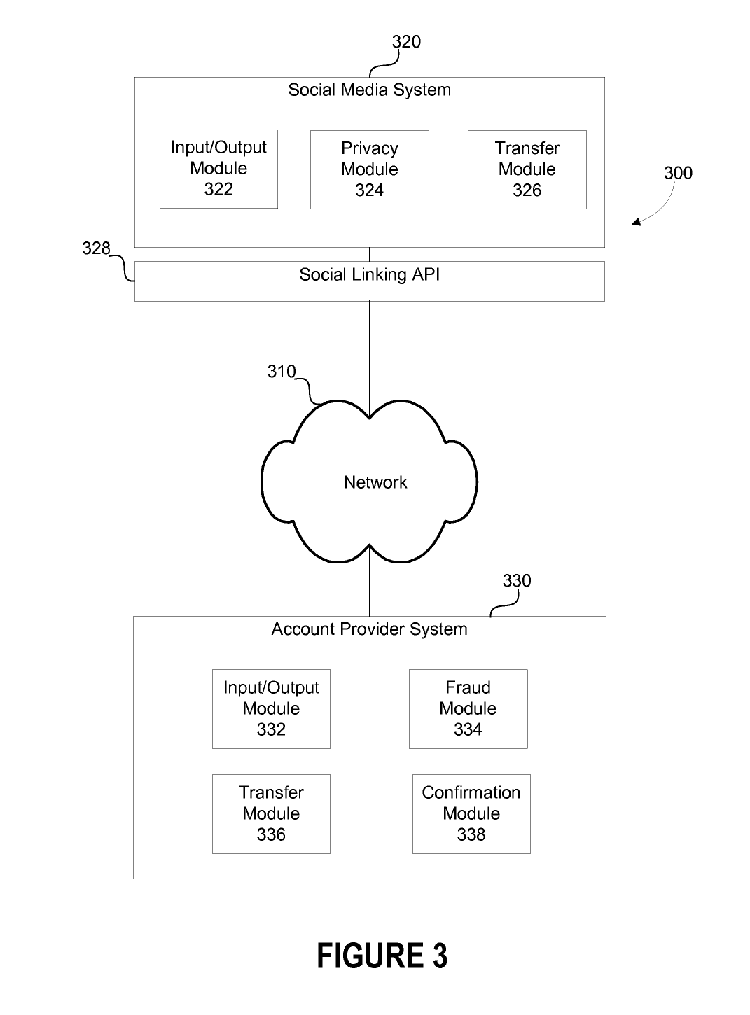

FIG. 3 illustrates various modules used in, for example, a social media system 320, which may be similar to social media system 120, and an account provider system 330, which may be similar to account provider system 130. As used herein, the term “module” may be understood to refer to computer executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

Social media system 320 may include an input/output module 322 and a privacy module 324. The input/output module 322 may include various hardware and software components, such as, for example, a repeater, a microwave antenna, a cellular tower, or another network access device capable of providing connectivity between network mediums. The input/output module 322 may be capable of sending or receiving signals via network 310. Moreover, the input/output module 322 may provide connectivity to one or more wired networks and may be capable of receiving signals on one medium such as a wired network and transmitting the received signals on a second medium such as a wireless network.

Privacy module 324 may include various hardware and software components, such as for example, data storage and at least one processor, capable of providing privacy features associated with a social media system 320. Privacy module 324 also may provide functionality associated with requiring approval of social media functionality available on social media system 320 so that only approved data is made available via social media system 320. For example, privacy module 324 may provide the functionality to allow a social media subscriber approve of a transfer request to transfer funds from a financial account to a recipient social media subscriber. Moreover, privacy module 324 may provide functionality to allow a social media subscriber to approve of publishing a completed transfer of funds to a recipient social media subscriber. In this example, a social media subscriber may select a listing of social media subscribers and/or individual social media subscribers that may view a transfer publication.

Transfer module 326 may include various hardware and software components, such as for example, data storage and at least one processor, capable of facilitating a transfer request. For example, transfer module 326 may receive data indicative of requested funds transfer from an account provider system 330 to an account associated with a recipient social media subscriber. The transfer module 326 may utilize, for example, a social linking API 328 to contact a recipient account provider system 330 so the recipient account provider system 330 may request a transfer from a sending account provider system 330. By way of example, this transfer may then be effected using an authorization network as illustrated in FIG. 2.

Social linking API 328 may allow certain data to be transmitted through the API so that a social media system may communicate with an account provider system. The social linking API 328 may prevent data other than approved data to be transmitted through the API 328. For example, the API 328 may only support subscriber name, subscriber e-mail address, subscriber identification information, and subscriber location information to be transmitted from the social media system to the account provider system. Also, the social linking API 328 may allow subscriber relationship data to be transmitted to the account provider system if a social media subscriber opts-in to allow relationship data to be provided to the account provider system.

By linking the social media system with the account provider system, an account holder authorizes the social media system to transmit certain subscriber data, such as subscriber location data, from the social media system to the account provider system. Moreover, by linking the social media system with the account provider system, a social media subscriber authorizes the account provider system to transmit account holder data, such as account data, including, for example, an account number and a routing number; a transfer amount; and/or recipient data, including, for example, recipient name, recipient email address, recipient phone number, and/or recipient social media identification data.

A social linking API 328 may provide encryption and filtering functionality to prevent, for example, identity theft and fraudulent transactions. For example, the social linking API 328 may filter out personally identifying information that is unnecessary to carry out the claimed methods, such as, social security numbers. A social inking API 328 may also encrypt, for example, account and routing numbers to ensure that any passing account identifying data is secure during transmission and storage.

Account provider system 330 may include an input/output module 332, a fraud module 2334, a transfer module 336, and a confirmation module 338. The input/output module 232 may include various hardware and software components, such as, for example, a repeater, a microwave antenna, a cellular tower, or another network access device capable of providing connectivity between network mediums. The input/output module 232 may be capable of sending or receiving signals via network 210. Moreover, the input/output module 232 may provide connectivity to one or more wired networks and may be capable of receiving signals on one medium such as a wired network and transmitting the received signals on a second medium such as a wireless network.

Fraud module 334 may include various hardware and software components, including data storage and at least one processor, to perform fraud detection. Fraud module 334 may access a social media API 328 in order to request and/or receive data from social media system 320. For example, fraud module 334 may receive data indicative of a transfer request from a sending social media subscriber and/or sending account holder. Fraud module 334 may then request social media data from a social media system 320 related to the transfer request, such as sending subscriber account data and/or recipient subscriber account data. Accordingly, account provider systems 330 are not required to store social media data, but instead may access social media data upon receiving data indicative of a transfer request. Fraud module 334 also may use a social media API to access social media system 320.

Fraud module 334 also may perform a fraud analysis using fraud detection algorithms. Fraud detection algorithms also may take into consideration sending account holder data, sending subscriber data, recipient account holder data, recipient subscriber data, time of day, transfer amount, and/or social media preference data.

Transfer module 336 may include various hardware and software components, such as data storage and at least one processor, to facilitate the transfer of funds from a sending account holder to a recipient account holder using a social linking API 328 and data from a social media system 320. For example, transfer module 336 may transmit a request to transfer funds from a sending financial account holder to a recipient social media subscriber. This request may be transmitted via network 310 to social media system 320 via a social linking API 328. Social media system 320 may transmit an identifier, such as a financial account identification number associated with the recipient social media account to the sending account provider system 330. Transfer module 336 may then prepare a funds transfer to a recipient financial account using the received financial account identifier(s). Transfer module 336 may then utilize an authorization network to transfer funds as illustrated in FIG. 2.

Confirmation module 338 may include various hardware and software components to perform methods for confirming a funds transfer has been received by a recipient financial account. Confirmation module 338 also may utilize a social media API 328 when transmitting confirmation data to a social media system 320. Confirmation data may include, for example, a receipt of transfer, a time and date of transfer, a sending account holder, a recipient account holder, a sending social media subscriber, and/or a recipient social media subscriber.

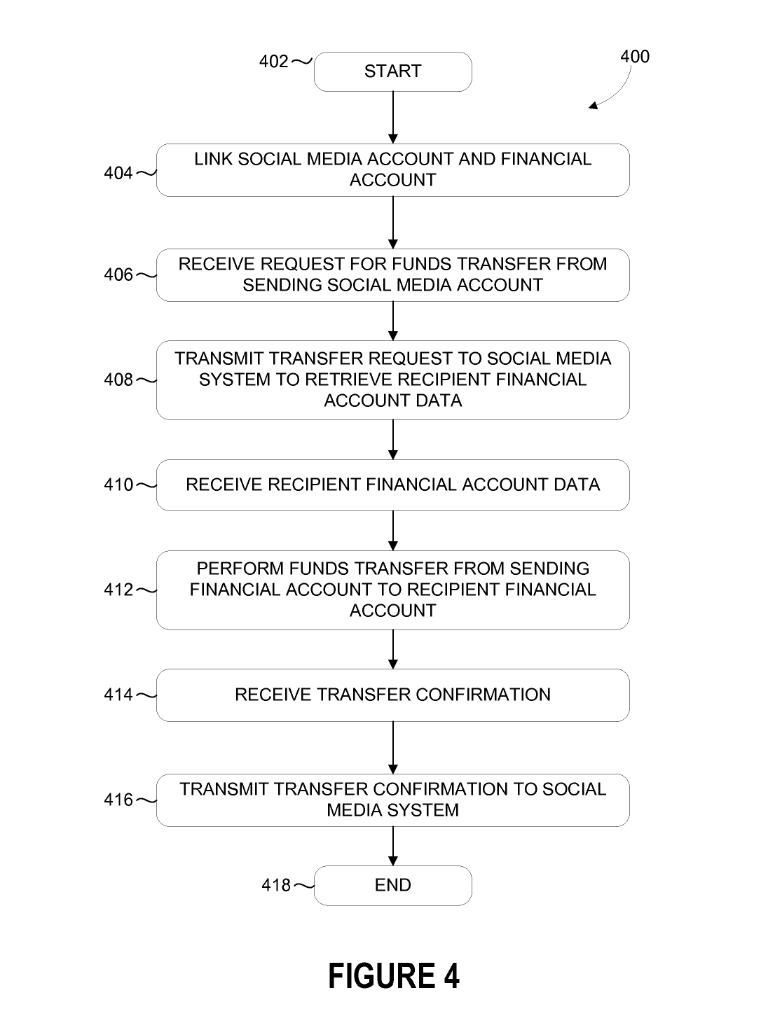

FIG. 4 illustrates a method for transferring funds from a financial account held at a financial institution to a recipient using a social media platform 400. The method 400 may begin at step 402. At step 404, a financial account holder may link a social media account to the financial account. Step 404 also may include a social media account holder linking a financial account to the social media account. A linking of accounts may be facilitated by a social linking API.

A social linking API may allow certain data to be transmitted through the API so that a social media system may communicate with a financial account provider system. The social inking API may format data to be transmitted between a social media system and a financial account provider system. The social linking API also may prevent data other than approved data to be transmitted through the API. For example, the API may only support subscriber name, subscriber e-mail address, subscriber identification information, and subscriber location information to be transmitted from the social media system to the account provider system. Also, the social linking API may allow subscriber relationship data to be transmitted to the account provider system if a social media subscriber opts-in to allow relationship data to be provided to the account provider system.

By linking the social media system with the account provider system, an account holder authorizes the social media system to transmit certain subscriber data, such as subscriber location data, from the social media system to the account provider system. Moreover, by linking the social media system with the account provider system, a social media subscriber authorizes the account provider system to transmit account holder data, such as account data, including, for example, an account number and a routing number; a transfer amount; and/or recipient data, including, for example, recipient name, recipient email address, recipient phone number, and/or recipient social media identification data.

A social linking API may provide encryption and filtering functionality to prevent, for example, identity theft and fraudulent transactions. For example, the social linking API may filter out personally identifying information that is unnecessary to carry out the claimed methods, such as, social security numbers. A social inking API may also encrypt, for example, account and routing numbers to ensure that any passing account identifying data is secure during transmission and storage.

Once a user has linked social media and financial accounts, a user may access a social media system, such as through a web interface and/or mobile application, to request a transfer of funds from a sending financial account to a recipient associated with a recipient social media account (step 406). Such a request may include, for example, a transfer amount, a transfer date, recipient social media identification data, and/or sender social media identification data. Social media identification data may include, for example, a name, an identification number and/or name, address, phone number, or the like.

Upon receiving a request for a funds transfer at a financial institution, the sending financial institution may transmit a transfer request to the social media system in order to obtain recipient financial account data (step 408). A transfer request may include, for example, the transfer amount and recipient social media identification data. Transfer request data, once received may be transformed and formatted into a query for use in step 410. Recipient social media subscriber may or may not have a linked financial institution account. Where recipient subscriber has a linked financial account, recipient may be prompted to link a financial account in order to receive the funds from the sending subscriber. The recipient subscriber may temporarily link a financial account in order to receive a one-time transfer or may save linked financial account data for future use.

In step 410, the social media system may query data storage for recipient financial account data using the received recipient social media identification data. Where recipient financial account data is unavailable, a social media system may prompt a recipient social media account holder for financial account data. A recipient social media account holder may be prompted via a push notification, SMS message, MMS message, voice call, voice mail, email, or the like. Recipient financial account data may then be transmitted from the social media system to the sending financial account provider system via a social linking API. Using a social linking API may not only provider proper formatting but also necessary encryption in transmitting sensitive data.

In step 412, a sending financial account system may perform a funds transfer to a recipient financial account system using, for example, a real-time funds transfer method, a batch processing funds transfer method, a wire transfer, and/or a clearinghouse transfer. In step 414, once a funds transfer is complete, a sending financial account provider system may receive a transfer confirmation from a recipient financial account provider system. In step 416, the sending financial account provider system may transmit a confirmation to a social media system. Upon receiving confirmation, a social media system may alert the sending social media account holder and/or the recipient social media account holder. Alerts may be sent in the form of an electronic message, push notification, email, text message voice message, or the like. The method may then end at step 418.

It should be appreciated that the foregoing discussion related to FIGS. 1 through 3 is illustrative only, and that the various embodiments of the disclosure may be implemented by any other appropriate system or method.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

I claim:

1. A system, comprising:
a social linking application programming interface (API) that establishes a link between a sender social media account that is associated with sender financial account data and at least one recipient social media account that is associated with recipient financial account data;
a database that maintains the link between the at least one linked sender financial account and at the least one linked recipient financial account;
an input/output interface that receives, via a network, a request from a sender financial institution identified in the linked sender financial account data to transfer funds from a sender social media subscriber associated with the sender social media account to a recipient social media subscriber associated with the recipient social media account, wherein the request identifies the linked recipient social media account and includes a transfer amount; and
a transfer processor that queries the data storage for recipient financial account data based on the request, transmits the recipient financial account data to a sender financial institution via the social linking API, and receives confirmation of a completed transfer between the sender financial institution and a recipient financial institution associated with the recipient financial account data.

2. The system according to claim 1, wherein the social linking API establishes and maintains a link between the sender social media account and the recipient social media account if the sender social media subscriber and recipient social media subscriber opt in to allow the social linking API to establish and maintain the link.

3. The system according to claim 1, wherein the social linking API filters personally identifying information that is unnecessary to establish and maintain the link.

4. The system according to claim 1, wherein the social linking API encrypts personally identifying information to establish and maintain the link.

5. The system according to claim 1, wherein, before the confirmation is received be the transfer processor, the sender financial institution analyzes the recipient financial account data using a fraud detection algorithm.

6. The system according to claim 2, further comprising a privacy processor that allows the sender social media subscriber and recipient social media subscriber to opt in to allow the social linking API to establish and maintain the link.

7. The system according to claim 1, wherein the request identifies the recipient financial institution.

8. The system according to claim 1, wherein the social linking API limits the data communicated through the social linking API.

9. A system, comprising:
a database that maintains a financial account of an account holder, wherein the account holder is a sender subscriber of a social media system;
a social media interface that is coupled via a network to a social linking application programming interface (API) that establishes a link between the sender subscriber's social media account and at least one recipient social media account that is associated with recipient financial account data, wherein the link is maintained in a database of the social media system; and
an input/output interface that transmits, via a network, a request to transfer funds from the financial account to a recipient social media subscriber associated with the recipient social media account, wherein the request identifies the linked recipient social media account and includes a transfer amount and confirmation of a completed transfer between the sender subscriber's financial account and a recipient financial institution associated with the recipient financial account data.

10. The system according to claim 9, wherein the social linking API establishes and maintains a link between the sender subscriber's social media account and the recipient social media account if the sender subscriber and recipient social media subscriber opt in to allow the social linking API to establish and maintain the link.

11. The system according to claim 9, wherein the social linking API filters personally identifying information that is unnecessary to establish and maintain the link.

12. The system according to claim 9, wherein the social linking API encrypts personally identifying information to establish and maintain the link.

13. The system according to claim 9, further comprising a fraud processer, wherein, before the confirmation is transmitted, the fraud processor analyzes the recipient financial account data using a fraud detection algorithm.

14. The system according to claim 10, further comprising a privacy processor that allows the sender social media subscriber and recipient social media subscriber to opt in to allow the social linking API to establish and maintain the link.

15. The system according to claim 9, wherein the request identifies the recipient financial institution.

16. The system according to claim 9, wherein the social linking API limits the data communicated through the social linking API.
